(19) United States
(12) Patent Application Publication
(10) Pub. No.: US 2010/0071007 A1
(43) Pub. Date: Mar. 18, 2010

(54) Method and Apparatus for Control of a Set-Top Box/Digital Video Recorder Using a Mobile Device

(75) Inventor: Johannes Meijer, Almelo (NL)

Correspondence Address: DORSEY & WHITNEY LLP;on behalf of EchoStar Technologies, L.L.C., 370 Seventeenth St., Suite 4700, Denver, CO, 80202-5647, US

(73) Assignee: EchoStar Global B.V., Almelo (NL)

(21) Appl. No.: 12/209,853

(22) Filed: Sep. 12, 2008

(51) Int. Cl. G06F 3/00

(52) U.S. Cl. 725/58

(57) ABSTRACT

One embodiment may take the form of a method and apparatus for controlling a set-top box (STB) or digital video recorder (DVR) through a mobile device. The STB may be configured to provide a reminder message to the mobile device of a user to notify the user that a particular program is available for viewing. In another embodiment, the user may reply to the reminder message through their mobile device to instruct the STB to record the desired program in the memory of the DVR. Thus, the user may instruct the DVR to record a program in response to a program reminder without the requirement of being in the same location as the STB.

### TECHNICAL FIELD

The present invention relates generally to set-top boxes, and more particularly to controlling a set-top box or a digital video recorder using a mobile device.

### BACKGROUND

Many digital cable, satellite or terrestrial television systems require a set-top box to receive an incoming television signal provided by the television provider. The set-top box may receive an encrypted signal and convert it into a signal that the user's television may recognize in order to display it to the user. Modern set-top boxes may also include several other features to enhance the viewing experience for the user. For example, many set-top boxes may contain an on-screen guide to inform the user of the available programs that may be viewed. Also, as discussed in more detail below, a set-top box may provide on-screen reminders to the user that a particular program may be viewed.

Many current set-top boxes may also include a digital video recorder contained within, or otherwise connected to, the set-top box. A digital video recorder is a device that may record video and/or audio in a digital format to a disk drive or other memory medium within the device. Through the digital recorder, a user may record a television program to a memory medium so that the program may be viewed by the user at a more convenient time. Recording the program may also allow the user to fast-forward or skip the unwanted sections of the program, as well as rewind to watch the program again. Thus, with the inclusion of the digital video recorder, a set-top box may not only receive and convert the television signal from the television provider, but may also record a television program for later playback by the user.

As mentioned above, one feature that may be provided by a set-top box is a program reminder that notifies the user that a particular program is available to be viewed. For example, a user may wish to view their local news broadcast. The user may then access a menu to set up a program reminder and select to receive a reminder of the local news broadcast. The set-top box may then monitor the incoming television signal to determine when the local news broadcast may air. When the news broadcast airs or some time before, the set-top box may provide an on-screen reminder to the user that the program is available to be viewed. The user may then switch channels to view the desired program. Alternatively, the STB may automatically switch over to the desired program without any input from the user when the program airs.

In set-top boxes with digital video recorders, the reminder described above may also be configured to record the desired program. For example, instead of reminding the user that the program is available to view, a reminder may be displayed on the user's television screen by the set-top box to notify the user that the program is available to be recorded for viewing at a later date. The reminder may further provide the user with the option of recording the program to memory by pressing a button on the user's remote control device or otherwise provide an indication to the set-top box that the user wishes to record the program. Thus, the on-screen reminder may function as a notification that the program is airing, as well as an providing the option to the user to record the program to the memory of the digital video recorder.

However, if the user is not watching the television screen when the reminder is generated by the set-top box, then the user may remain unaware that the desired program is airing. Further, without the reminder, the user may be unable to instruct the set-top box and digital video recorder to record the program for later viewing. Thus, the user may miss the desired program entirely. Therefore, what is needed is a method for the user to use a mobile device to instruct the digital video recorder to record the program for later viewing, perhaps in response to a program reminder sent to the user's mobile device.

### BRIEF SUMMARY

One embodiment of the present invention may take the form of a method for providing a program reminder to a user. The method may comprise receiving an indication from the user of interest in a program. The method may also include generating the program reminder when the media program is available and transmitting the program reminder to a mobile device for display to the user.

Another embodiment may take the form of a method for communicating with a set-top box using a mobile device. The method may comprise generating a program reminder configured to notify a user about a media program, transmitting the program reminder to a mobile device for display to the user and monitoring for receipt of a response to the program reminder.

Yet another embodiment may take the form of a system for providing a program reminder to a mobile device. The system may comprise a set-top box configured to generate information about a media program and a modem operably connected to the set-top box. The modem may be configured to transmit the information about the media program over a network connection. The system may also include a headend operably connected to the modem, where the headend may be configured to receive the information about the media program over the network connection.

### BRIEF DESCRIPTION OF THE DRAWINGS

FIG. 1 depicts a first embodiment of a mobile device controlling a set-top box/digital video recorder through a network connection.

FIG. 2 depicts a second embodiment of a mobile device controlling a set-top box/digital video recorder through a headend of a satellite television system.

FIG. 3 is a flowchart depicting a method for a set-top box/digital video recorder to provide a program reminder to a mobile device such that the mobile device may be used to control the set-top box/digital video recorder.

### DETAILED DESCRIPTION

One embodiment may take the form of a method and apparatus for controlling a set-top box (STB) or digital video recorder (DVR) through a mobile device. As used herein, “STB” includes a set-top box that may also include a digital video recorder contained within, or otherwise connected to, the set-top box. The STB may be configured to provide a reminder message to the mobile device of a user to notify the user that a particular program is available for viewing. In one embodiment, the reminder may be sent from the STB to the user's mobile network for transmission to the user's mobile device. In another embodiment, the reminder may be generated by a head-end of the television provider system and sent to the user's mobile network from the head-end. Thus, the user of the embodiment may receive a program reminder on the user's mobile device, without the need to be near the STB, or viewing an associated television.

Further, the reminder message transmitted to the user's mobile device may be configured to query the user as to whether the desired program is to be recorded on the DVR. In another embodiment, the user may reply to the reminder message through his mobile device to instruct the DVR to record the desired program in the memory of the DVR. Such communications may employ, for example, short message service (SMS) or multimedia message service (MMS) technology. Thus, the user may instruct the DVR to record a program in response to a program reminder without necessarily being in the same location as the DVR. Instead, the user may send a text message to the STB to instruct the DVR to begin recording the program. In an alternate embodiment, the user may use a mobile device to instruct the DVR to begin recording a program without first being reminded by an SMS or MMS reminder message.

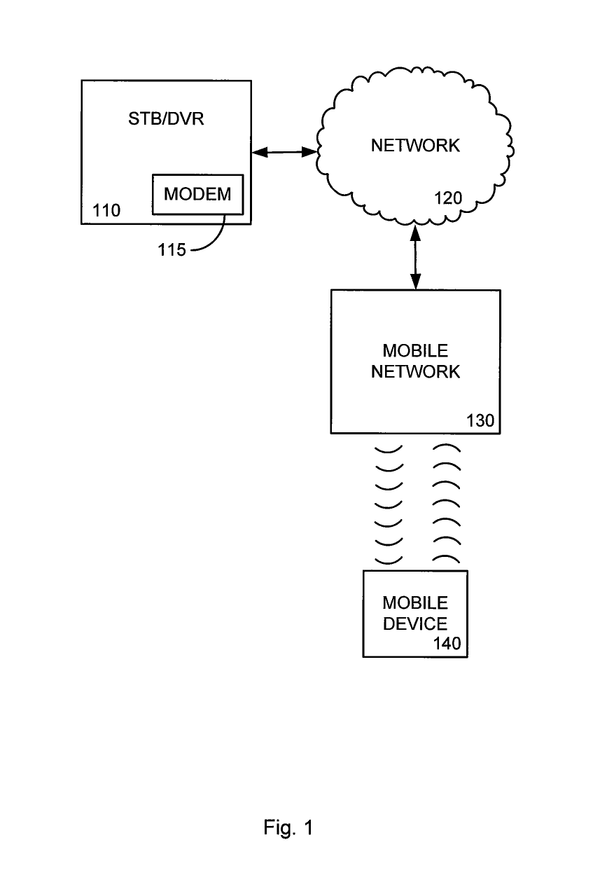

FIG. 1 depicts a first embodiment of a mobile device controlling a set-top box/digital video recorder through a network connection. The embodiment may allow a user to receive a program reminder on the user's mobile device, as well as respond to that reminder to instruct a DVR to record the program for later viewing.

As described above, an STB 110 may receive an encrypted signal from a television provider and convert it into a signal that the user's television may recognize and display to the user. The STB 110 may also provide other functionality to the user, including an on-screen guide and program reminders on the user's television to notify the user when a particular program may air. Further, a STB containing a DVR may digitally record a television program into a memory for playback by the user at a later time. Thus, an “STB” as used herein, encompasses any type of device that may provide the user of a television system with a program reminder and may record a television program for later playback.

In communication with or incorporated into the STB 110 may be a modem device 115. The modem device may be a part of the STB 110 or may be separate from the STB 110. The modem device 115 may have an internet protocol (IP) address associated with it and may be used by the STB 110 to communicate across a network with another electronic device such as a mobile device 140. As another example, a typical phone line, a broadband connection, or other land-based connection may be connected to the STB 110. The STB 110 may utilize the modem device 115 to communicate through the phone line and a network to a server maintained by the television provider. Some other examples of the communication line connecting the STB 110 to the network may be, but are not limited to, a wireless connection, an ethernet connection or a coaxial connection.

As described above, the STB 110 may generate and provide a program reminder to a user of the STB. The program reminder may notify the user that a particular program may be available to be viewed, may query the user if the particular program should be recorded by the DVR, or may remind the user that a particular program is set to be recorded. The reminder may be generated by the STB 110 to appear on the screen of the television connected to the STB. However, if the user is not watching the television when the reminder appears on the television screen, the user may not receive the reminder or may receive it too late to record or view the program. In this circumstance, the user may indicate to the STB that the user may be away from the user's television, perhaps by toggling a switch on the STB with “home” and “away” modes. Other indicators to the STB may be a “standby” or “screensaver” mode. Thus, the embodiment may provide the same or a similar program reminder to the user's mobile device 140 such that the user may be notified of the program no matter where the user is located. Alternatively, the program reminder sent to the user's mobile device 140 may be a simple text message containing information about the program.

To provide the user with the program reminder, the STB 110 may generate a text or multimedia message to send to the user's mobile device. The text message may be based on SMS or MMS technology currently supported by most mobile devices. SMS technology is a communication protocol allowing the interchange of short text messages between mobile devices. Once generated by the STB 110, the text message may be sent through the modem device 115 to a network 120. The network 120 may receive the text message generated by the STB 110 and route it based on the forwarding information contained within the message. The network 120 may forward the program reminder to the user's mobile network 130 for delivery to the user's mobile device 140. Alternatively, the network 120 and the user's mobile network 130 may be a single network.

The STB 110 may also be configured to provide the user with the ability to select which program reminders are sent to the user's mobile device 140. For example, the user may have reminders to view or record several programs offered by the television provider. However, some reminders may be set to automatically record or switch to the program without any input provided by the user. Other reminders may ask the user whether they wish to record or switch to the program before the program is viewed. Still other reminders may provide a notice to the user that the program is available without providing the user with an option of recording or switching to the program, requiring the user to switch the channel manually. Thus, the user may receive many on-screen reminders from the STB 110, but may not want to receive every reminder on the user's mobile device 140. Therefore, the STB 110 may be configured to provide the user with the ability to select which program reminders are sent to the user's mobile device 140. The user's preference to which reminders are received may be collected from the user when the user inputs information about the user's mobile device 140 or when the user sets up the program reminder. Alternatively, an on-screen guide may assist the user in selecting which reminders are forwarded to the user's mobile device 140.

The STB 110 may also provide the user with other methods of control when the program reminders are sent to the user's mobile device 140. For example, the STB 110 may have a switch on the front of the device that the user may use to inform the STB that the user wishes to receive the reminders. Alternatively, the user may access an on-screen menu to indicate to the STB 110 that the user will be away from the television and wishes to receive the reminders on the user's mobile device 140. Generally, any input may be provided to the STB 110 by the user to indicate to the STB that the user wishes to receive the program reminders on the user's mobile device 140.

The text message generated by the STB 110 may contain information to assist in the delivery of the message as well as information about the particular program of interest to the user. For example, the generated message may contain information about the mobile device 140 the message will ultimately be delivered to. This information may be used by the network 120 to route the message to the correct mobile network 130 as well as to transmit the message to the correct mobile device 140 on that particular mobile network. The routing information may be contained in a header attached to the text message or may be contained within the body of the message.

To include the proper routing information in the generated text message, the STB 110 may have access to identification information about the mobile device 140. For example, the STB 110 may store the routing information for the user's mobile device 140 within the memory of the STB. This information may be provided to the STB 110 by the user himself, or through an outside party with access to the STB. To provide the routing information to the STB 110 directly, the user may access an on-screen guide through, for example, a remote control. In another embodiment, the user may provide this information to the satellite signal provider or another third party that has access to the STB 110. This information may then be transmitted to the STB 110 from the third party and stored therein. Thus, the STB 110 may include such information in the generated program reminder.

As previously mentioned, the generated text message may also contain information about the program that is the subject of the reminder. For example, the generated text message may contain information to identify a local news broadcast that the user may have previously selected or otherwise indicated as being of interest. This information may be in the form of a unique ID that identifies that particular broadcast. In one embodiment, the unique ID may be in the form of the title of the program. In addition, the text may contain information that provides further details about the program to the user, including, but not limited to, the title of the program, run times of the program, information about the channel on which the program will air, or information about the contents of the program. This information may be presented to the user on the user's mobile device 140 such that the user can identify the program that is the subject of the reminder (and, optionally, its contents).

The user may use various search criteria when requesting a program reminder. For example, as explained above, the user may wish to receive a reminder based on the title of the program. Alternatively, the user may wish to receive a reminder for each program that includes a specific actor. Other search criteria may include, but is not limited to, the subject of the program or a specific genre, such as sports. Generally, the STB may provide a reminder to the user based on any information about the program that is maintained by the STB.

Also included in the text message generated by the STB 110 may be information about the STB, such that a return message may be sent by the user's mobile device 140. For example, each STB 110 of a television network may have a smart card associated with it. Each smart card may have a unique number that may be used to distinguish the user's STB 110 from the other STBs on the television network. Thus, the STB 110 may include this unique smart card number within the generated text reminder sent to the user's mobile device 140. As described in more detail below, if the user that receives the reminder on the mobile device 140 responds to the text message, the identifying information about the STB 110 may be used to provide the return routing information for the response.

As mentioned above, the generated text message containing the program reminder may be sent through the modem device 115 of the STB 110 to a network 120. Using the routing information contained within or appended to the text message, the network 120 may transmit the message to the user's mobile network 130. The mobile network 130 may, in turn, broadcast the message to the user's mobile device 140. As mentioned above, in some embodiments, the network 120 and the user's mobile network 130 may be a single network. Any mobile device that is configured to receive a text message based on SMS or MMS technology may receive the program reminder. Some mobile devices 140 that may support SMS or MMS text messaging include, but are not limited to, handheld computing devices, personal digital assistants, mobile telephones, notebook computers, personal media players (PMP), music or audio players (such as an MP3 player), a wide area network (WAN) device, a Bluetooth device and so on. The mobile device 140 may receive the text or multimedia message and convert the message into a viewable format to be displayed by the device to the user. Once converted into the viewable format, the text or multimedia message may be viewed by the user on the user's mobile device 140.

As also mentioned above, many program reminders may ask for an input from the user to either switch to the channel on which the desired program is airing or to instruct the DVR to record the program for viewing at a later time. Generally, the input is provided to the STB 110 through the user's remote control while the user is watching the television. In a similar manner, however, the user may use the mobile device 140 to respond to the program reminder to instruct the DVR to begin recording the program.

Upon receiving the text message program reminder, the user may view the reminder on the user's mobile device 140. The reminder may query the user as to if the user wishes to record the subject program. If the user so desires, he may respond to the text message by provided a return message with some indication to the DVR to record the program. Any message that is recognized by the STB 110 may be provided in response to the reminder. For example, the user may simply respond to the reminder by typing “yes” and transmitting that text back to the STB 110. Other responses may have the user respond by returning a text with a special program ID number or other designated code. Generally, the STB 110 may be programmed to recognize any type of text message in response to the reminder as an indication that the user wishes to record the program.

After responding to the program reminder, the user may send the response message back to the STB 110. The return path may be similar to the path that the program reminder message took to the mobile device 140, but reversed. Thus, the response message may be transmitted by the user's mobile device 140 to the user's mobile network 130, which may route the response to a network 120. The network 120 may, in turn, route the response message to the IP address associated with modem 115 of the STB 110. The IP address of the STB 110 may be included as part of the program reminder text message. The STB 110, upon receipt of the response message, may determine if the user has instructed the DVR to record the program. If the user has provided the correct indication to record the program, the DVR may be configured to record the program when the program starts.

The user may also send a text message to the STB 110 without first receiving a reminder from the STB. For example, the STB 110 may be configured to receive a text message from the user's mobile device 140. The text message may be an instruction to the STB 110 to record a particular program and may be transmitted to the STB in a same manner as described above. The STB 110 may receive the instruction from the network 120 and may set a timer to record the desired program. The text message instruction may in a form that may be recognized by the STB 110 such that the STB may determine which program is to be recorded. Thus, in this manner, the user may use a mobile device 140 to set a timer to record a program over a network 120 without the requirement of being near the STB 110. After the timer is set by the STB 110, the program may be recorded when the program airs.

The user's mobile device 140 may also be used to manage timers set by the STB 110. For example, a playlist of set timers may be provided to the user's mobile device 140 by the STB 110 in a similar manner as described above for sending a program reminder. The playlist may contain each timer currently set by the STB 110. The user may use his mobile device 140 to send an instruction to the STB 110 to ignore or erase one or more of the timers in the playlist. The user 140 may also select which timer is preferred when two timers may conflict. The instruction sent to the STB 110 by the user's mobile device 140 may be a text message that may be transmitted over a network 120. The text message instruction may in a timer is to be deleted or ignored. In this manner, the user may use a mobile device 140 to manage timers set by the STB to record programs.

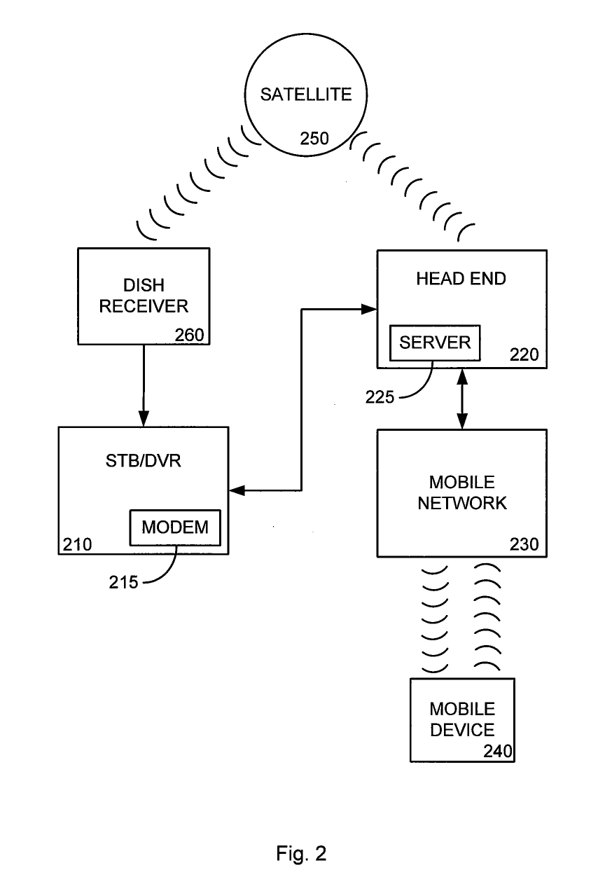

FIG. 2 depicts a second embodiment of a mobile device controlling a set-top box/digital video recorder through a satellite television system. Similar to the embodiment depicted in FIG. 1, this embodiment may allow a user to receive a program reminder on the user's mobile device 240 and respond to that reminder to instruct a DVR to record the program. However, this embodiment may also return the response message to the STB 210 through an alternate path than the reminder message was delivered to the mobile device 240.

Similar to the embodiment of FIG. 1, this embodiment may also take the form of a STB 210 that may receive an encrypted signal from a television provider and convert it into a signal that the user's television may recognize and display to the user. The STB 210 may also provide program reminders as described above. In communication with or incorporated into the STB 210 may also be a modem device 215. However, this modem device 215 may be used by the STB 210 to communicate with a headend 220 as well as connecting to a network. The modem device 215 may communicate with the headend 220 through several types of connections, including but not limited to, a typical phone, a wireless connection, an ethernet connection or a coaxial connection.

The headend 220 may be a master facility that receives television signals for processing and distribution to various television systems. For example, a satellite television provider headend 220 may receive television programs from the program producers. After receiving the programs, the headend 220 may process the programs (or other audio/visual presentations) to put them into a transmission format and broadcast those programs to subscribers. In a satellite television provider, the headend 220 may transmit the audio/visual signal to a satellite for redistribution to subscribers. In a cable television system provider, the headend 220 may transmit the television signal directly to the STB of the users over a cable network. Some content delivery systems may include several headends located throughout the network, each serving a subset of subscribers.

The headend 220 may include a server 225 that receives communications from several STBs 210 or may be dedicated to a single STB. The server 225 may communicate to the STB 210 to provide data or services for the STB. For example, the STB 210 may communicate to the headend 220 to purchase a pay-per-view event, to provide information about the status of the STB 210, or to receive software updates from the headend 220. As described in more detail below, the server 225 and headend 220 may also generate a text message program reminder based on the information provided by the STB 210 through the modem 215.

As with the embodiment of FIG. 1, the STB 210 of this embodiment may also be configured to provide a program reminder to a user on a user's mobile device 240. To provide the program reminder to the user's mobile device 240, the STB 210 may first provide information to the headend 220. Such information may include information about the program that is the subject of the reminder, as well as information about the STB 210 itself. The headend 220 may use the information provided by the STB 210 to generate the text message reminder that is transmitted to the user's mobile device 240.

For example, the user may configure the STB 210 to provide a program reminder about a local news broadcast to the user's mobile device 240. When the STB 210 determines that the program reminder should be sent, it may transmit information to the headend 220 through the modem 215 to the server 225. The information provided by the STB 210 may include information about the program as described above with reference to FIG. 1. Further, the STB 210 may provide information about the user's mobile device 240 to the headend 220 to assist the headend in properly transmitting the program reminder to the mobile device 240.

After receiving the program reminder information from the STB 210, the headend 220 may generate a text message program reminder to be sent to the user's mobile device 240. For example, the headend 220 may receive the program information provided by the user's STB 210 and insert that information into a generated text message. Further, the headend 220 may also use the information about the user's mobile device 240 to transmit the text message program reminder to the user's mobile network 230. Alternatively, the headend 220 may store much of the information needed to generate the text message reminder. For example, the STB 210 may provide a unique program ID number to the headend 220. The headend 220 may retain a list of available programs and the unique ID associated with each program. Thus, if the STB 210 provides a unique ID number for the desired program, the headend 220 may then access the program list to identify the desired program. Further, the program list may contain detailed information about the program, including title and start/stop times. The program information gathered from the program list may included in the text message reminder sent to the user's mobile device 240.

The headend 220 may also store information about the user's mobile device 240. For example, several STBs 210 in the network may be registered with a single headend 220. The headend may communicate with each STB connected to it using a unique smart card identification number associated with each STB. Further, each user of the television system may provide information about the user's mobile device 240 to the headend 220 during installation. The user's mobile device 240 information and the STB 210 that is associated with the user may then be stored in a look-up table by the headend 220. Thus, when a program reminder request is received from the STB 210, the headend may use the unique smart card number associated with the user's STB 210 to determine information about the mobile device 240 of the user, such as the mobile device number and network. The user's mobile device 240 information may then be used by the headend 220 to generate a text message program reminder to send to the user's mobile device.

Once the text message is generated by the headend 220, the message may be sent to the user's mobile network 230 using SMS or MMS technology as described above. The user's mobile network may use the routing information associated with the text message to transmit the text message to the user's mobile device 240 for viewing by the user. In this manner, the user may receive a program reminder from the STB 210 on the user's mobile device.

Alternatively, a specially configured server may act as the headend in the example provided above. Thus, the server may receive information from the STB 210. The information provided by the STB may be include information about the program that is the subject of the reminder, as well as information about the STB 210 itself. The server may use the information provided by the STB 210 to generate the text message reminder that is transmitted to the user's mobile device 240.

Similar to the embodiment described inn reference to FIG. 1, the embodiment of FIG. 2 may also provide the user with the option of returning a message to the STB 210 in response to the program reminder. The user may respond to the reminder with any response that is recognized by the STB 210. The response message may be transmitted from the user's mobile device 240 to the user's mobile network 230 then to the headend 220 by using the routing information contained within the response message. From the headend 220, the response message may be communicated to the STB 210 through the server 220 in a similar fashion as described above. Alternatively, in a satellite television system, the headend 220 may transmit the response message to a satellite 250 that is part of the television system. The satellite 250 may in turn transmit the response message to the user's dish receiver 260 for delivery to the user's STB 210. Along the path of the return message, the message may be converted into any format that may be recognized, transmitted or received by the components of the system, such as the satellite 250 and dish receiver 260. Upon receipt of the response message, the DVR 210 may then schedule or begin recording the desired program as described above.

Alternate embodiments may utilize a subscription service to provide the program reminders to the user. For example, as mentioned above, the STB or the headend may provide a program reminder to the user on the user's mobile device. The reminder service may be provided once a user has subscribed to receive the reminder. After subscribing, the STB or the headend may store an indication that the user has subscribed to the reminder service. Thus, the STB or the headend that provides the reminder may determine if the user has subscribed to receive the reminder before generating and transmitting the reminder to the user's mobile device.

To subscribe to receive the program reminders, the user may request the service from the television provider or from a third party. The user may also agree to pay a monthly or one time fee for the service of receiving the program reminders. When the subscription service is provided by a third party, an additional determination may be performed by the third party. In this example, the program reminder may be generated by the STB or the headend and provided to the third party. The third party may then determine if the user has subscribed to receive the program reminder before transmitting the program reminder to the user's mobile device. Alternatively, the third party may generate the program reminder and transmit the reminder to those user's that have subscribed to the reminder service.

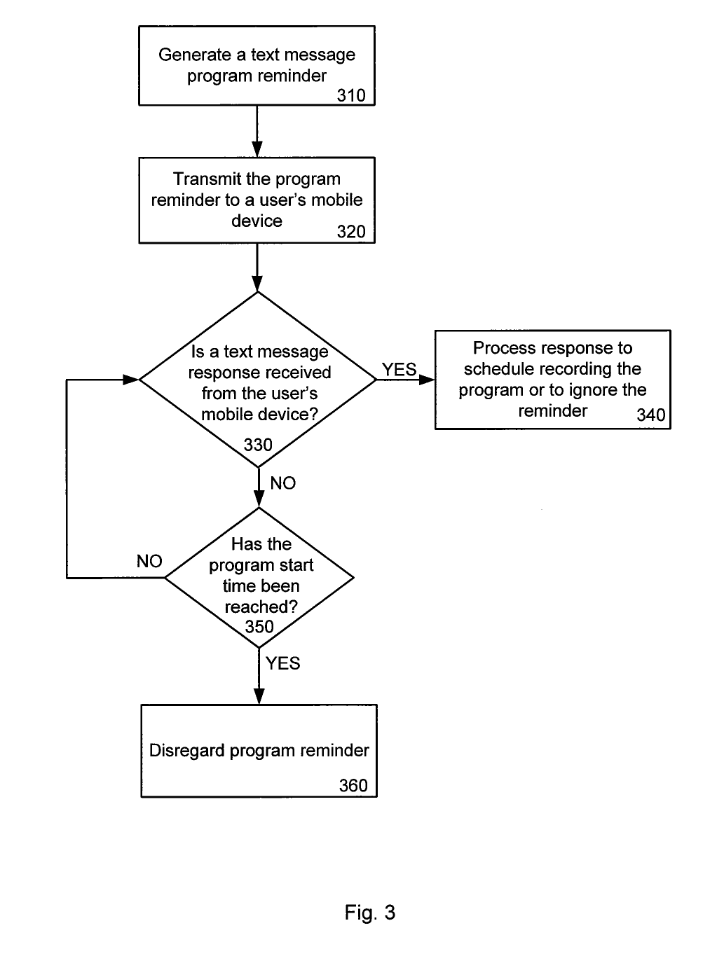

FIG. 3 is a flowchart depicting a method for a set-top box/digital video recorder to provide a program reminder to a mobile device such that the mobile device may be used to control the set-top box/digital video recorder. Through the method, a user may instruct the DVR to record a program without the requirement of being near the DVR device.

The embodiment may begin in operation 310 by generating a text message including a program reminder. The program reminder may contain information about the program including the program title, the start and stop times of the program, and detailed information about the program. The text message may further include a query to the user whether the user desires to record the program. As described above, this text message may be generated by the user's STB or by a headend of the user's television system.

In operation 320, the generated text message reminder may be transmitted to the user's mobile device. The program reminder may be transmitted to the user's mobile device by the user's STB or by a headend of the television system. As described above, the text reminder may be transmitted to the user's mobile network and then to the user's mobile device such that the user may view the reminder on the display of the mobile device. Upon receipt of the text reminder, the user may view the message or provide a response to the message to record the program.

Operation 330 may determine whether a text message response is received from the user's mobile device. This response may be a text message containing an instruction to the user's DVR to record the program that is the subject of the program reminder or to ignore the reminder and not record the program. The response may be transmitted by the user's mobile network to a headend of the television system or to the user's STB. This message may also be in generated by the user's mobile device using SMS or MMS technology.

If a response is received in operation 330, then the response may be processed by the STB. The response may instruct the STB to record the program when it airs or to ignore the program reminder and not record the program. If the response instructs the STB to record the program, a timer may be set by the STB to record the program when the program begins. If a response is not received in operation 330, operation 350 may determine if the program start time has been reached. If the program start time has not been reached, then the method may return to operation 330. However, if the program start time has been reached, the STB may disregard the program reminder in operation 360.

An alternative embodiment may include an advertisement with the program reminder. As described above, an STB or a headend may provide a program reminder to a user on the user's mobile device. Along with the program reminder, an advertisement may also be provided to the user's mobile device. The advertisement may include information on upcoming television programs that the user may be interested in. For example, the viewing habits of the user may be collected and stored by the STB or the headend. This information may be used to determine which television programs the user may be interested in viewing. Thus, when a program reminder is sent to the user, the advertisement for the selected program may also be provided to the user's mobile device. Alternatively, the advertisement may be sent to the user's mobile device without accompanying a program reminder. Instead, the STB or headend may select the advertisement and transmit it to the user's mobile device between the program reminders.

The user may also respond to the advertisements in a similar manner as described above. For example, the user may receive an advertisement for a program that may be of interest to the user. The advertisement may include a request to respond to the advertisement to record the advertised program. Thus, the user may send a text response to the advertisement as described above to set a timer to record the advertised program. In this manner, the advertised programs may act as program reminders without requiring the user to request the particular program reminder.

It should be noted that the flowchart of FIG. 3 is illustrative only. Alternative embodiments of the present invention may add operations, omit operations, or change the order of operations without affecting the spirit or scope of the present invention.

The foregoing merely illustrates the principles of the invention. Various modifications and alterations to the described embodiments will be apparent to those skilled in the art in view of the teachings herein. It will thus be appreciated that those skilled in the art will be able to devise numerous systems, arrangements and methods which, although not explicitly shown or described herein, embody the principles of the invention and are thus within the spirit and scope of the present invention. From the above description and drawings, it will be understood by those of ordinary skill in the art that the particular embodiments shown and described are for purposes of illustration only and are not intended to limit the scope of the present invention. References to details of particular embodiments are not intended to limit the scope of the invention.

What is claimed is:

1. A method for providing a program reminder to a user, the method comprising:
receiving an indication from the user of interest in a program;
generating the program reminder when the media program is available; and
transmitting the program reminder to a mobile device for display to the user.

2. The method of claim 1, further comprising:
receiving a response to the program reminder from the user, wherein the response includes an instruction to record the media program; and
configuring the set-top box to record the media program.

3. The method of claim 1, wherein the program reminder is generated using at least one of Short Message Service (SMS) technology and Media Message Service (MMS) technology.

4. The method of claim 1, wherein the program reminder is transmitted across at least a mobile network.

5. The method of claim 1, wherein the program reminder is transmitted across at least a first network and a second network, wherein the second network transmits the program reminder to the mobile device.

6. The method of claim 1, wherein the mobile device is at least one of: a handheld computing device; a personal digital assistant; a mobile or cellular telephone; a notebook computer; personal media player (PMP); and an audio player.

7. The method of claim 1, wherein the mobile device is at least one of: a wireless device; a Bluetooth device; and a wide area network (WAN) device.

8. The method of claim 1, wherein the program reminder contains information about the media program chosen from the group comprising: the title of the media program; the start and end time of the media program; and the channel the media program will air.

9. The method of claim 2, wherein the response includes an instruction to change a recording parameter, the method further comprising:
changing the recording parameter.

10. The method of claim 1, wherein the transmitting operation occurs after receiving an indication that the user has subscribed to a program reminder service.

11. The method of claim 1, wherein the program reminder includes an advertisement.

12. A method for communicating with a set-top box using a mobile device, the method comprising:
generating a program reminder configured to notify a user about a media program;
transmitting the program reminder to a mobile device for display to the user; and
monitoring for receipt of a response to the program reminder.

13. The method of claim 12 wherein, in the event that a response to the program reminder is received, the method further comprising:
processing the response for an instruction to record the media program; and
configuring the set-top box to record the media program.

14. The method of claim 12, wherein, in the event that a response to the program reminder is not received by a program start time, the method further comprising:
not recording the media program.

15. The method of claim 13, wherein the program reminder and response are generated using at least one of SMS technology and MMS technology.

16. The method of claim 12, wherein the program reminder contains a program identification code that identifies the media program.

17. The method of claim 13, wherein the response to the program reminder contains the program identification code.

18. The method of claim 13, wherein the response is received by the set-top box through a satellite communication device.

19. A system for providing a program reminder to a mobile device, the system comprising:
a set-top box configured to generate information about a media program;
a modem operably connected to the set-top box, the modem configured to transmit the information about the media program over a network connection; and
a headend operably connected to the modem, the headend configured to receive the information about the media program over the network connection.

20. The system of claim 19, wherein the headend generates the program reminder based on the information about the media program provided by the set-top box.

21. The system of claim 19, further comprising:
a server associated with the headend, the server configured to transmit the program reminder to the mobile device through a mobile network.

22. The system of claim 20 wherein the information about the media program includes a program identification code that identifies the media program and wherein the headend accesses a database containing the program identification code to generate the program reminder.

23. The system of claim 20 wherein the program reminder is generated using at least one of SMS technology and MMS technology.
